(19) United States
(12) Patent Application Publication
(10) Pub. No.: US 2025/0278645 A1
(43) Pub. Date: Sep. 4, 2025

(54) AUTONOMOUS RECOMMENDATION SYSTEMS USING MACHINE LEARNING

(71) Applicant: THE TORONTO-DOMINION BANK, TORONTO (CA)

(72) Inventor: AZKA IFTIKHAR KHAN, LONDON (CA)

(21) Appl. No.: 19/067,378

(22) Filed: Feb. 28, 2025

Related U.S. Application Data
(60) Provisional application No. 63/560,538, filed on Mar. 1, 2024.

(51) Int. Cl. G06N 5/022; G06N 5/01

(52) U.S. Cl. CPC G06N 5/022; G06N 5/01

(57) ABSTRACT

An AI-driven recommendation system utilizes a machine learning model and a dynamically updated knowledge graph to generate personalized product recommendations. The system constructs a knowledge graph with nodes and edges representing relationships between users, prior product selections, and historical interactions. A supervised learning framework trains the machine learning model using labeled data from the knowledge graph to predict relevant products based on multi-dimensional constraints. A graphical user interface (GUI) presents dynamically adjusted interactive elements to capture user preferences. User responses are processed using natural language processing (NLP) to refine predictions and generate recommendations. The system continuously updates the knowledge graph with real-time user feedback and external data, retraining the machine learning model to enhance future recommendations. This adaptive approach enables personalized, context-aware recommendations that evolve based on user interactions and external influences.

### CROSS-REFERENCE TO RELATED APPLICATION

This application claims priority to and benefit from U.S. Patent Application Ser. No. 63/560,538 filed on Mar. 1, 2024, which is hereby incorporated by reference in its entirety.

### FIELD

The present invention relates to computer-implemented systems and methods for autonomously recommending digital products using machine learning and more specifically to monitoring interactions with computer applications and recommending digital products based on digital engagement with one or more computing devices.

### BACKGROUND

Existing digital platforms and computer applications often struggle to accommodate highly specific and dynamically evolving user interactions on a digital computing environment. Conventional systems typically operate within rigid recommendation frameworks that do not effectively integrate complex interactions and other system or digital environment criteria. As a result, users of the digital platforms may receive digital recommendations (e.g. of e-commerce products, digital offerings, digital resources) that fail to align with their personalized constraints, leading to less effective automated selection processes.

Additionally, many of these digital recommendation systems are unable to adapt to changing needs and become obsolete for digital users who want to avoid traditional digital offerings or products.

Traditional recommendation engines and filtering mechanisms face challenges in processing and adapting to multi-dimensional, constantly shifting constraints. These systems often rely on static rule sets or generalized models that lack the computational flexibility needed to incorporate evolving parameters. Additionally, existing methods exhibit limitations in efficiently handling large-scale data processing while maintaining high levels of precision and adaptability to real-time modifications.

### SUMMARY

To address these limitations, there is a need for an intelligent, autonomous computerized system capable of dynamically generating and refining digital recommendations of digital offerings or products based on continuously evolving, multi-parametric constraints. In at least some aspects, such a system processes vast amounts of structured and unstructured data, infer user-defined requirements with minimal delay, and optimize recommendations while ensuring scalability and computational efficiency.

In at least some aspects, such a system provides personalized recommendations that evolve alongside users' changing preferences. It must be able to analyze large datasets, interpret individual needs, and generate digital suggestions that account for various considerations and preferences. Additionally, the system preferably offers flexibility to adapt to shifting values and external conditions, ensuring long-term relevance and user satisfaction.

It is generally difficult to democratize access to a broader range of products while ensuring alignment with diverse user preferences, various considerations, and regulatory standards. To address this challenge, it would be helpful to provide a system, method, device and technique to addresses the challenges of meeting diverse computer application customer needs by introducing an advanced autonomous and computerized system enabled by artificial intelligence.

In at least some aspects, there is a method or system that employs a machine learning model that integrates decision tree-based algorithms with a dynamically updated knowledge graph. This knowledge graph comprises nodes and edges representing relationships between users, products, and historical interaction data, and it is continuously enriched with real-time user feedback and external data. The machine learning model is trained on labeled data from the knowledge graph to predict user preferences based on multi-dimensional constraints to generate highly personalized recommendations that adapt to evolving customer needs, external factors, and regulatory changes.

In some aspects, as user input is received on a graphical user interface regarding user preferences, such as avoiding specific industries or adhering to certain guidelines, the AI engine or component refines its understanding of their needs. Through the GUI screens, the method or system suggests tailored products and sub-products, enabling users to create personalized portfolios that meet their unique preferences. The computer application can also receive requests via the GUI to rank products based on adherence to specific criteria, allowing for more precise control over their decisions.

In at least some aspects, the method or system supports a wide range of digital products. For example, the system can generate recommendations that include compliant digital instruments, ESG (Environmental, Social, and Governance) aligned digital products or resources, or sustainability-focused e-commerce products, considered as examples only. However, the system is not limited to such offerings and may offer other digital products or services, or digital resources as envisaged by the current disclosure. In at least some aspects, the system is capable of generating personalized recommendations for various computing resources based on user inputs and preferences. For example, the system can suggest software tools, platforms, or cloud services that meet specific user requirements, as well as development frameworks, APIs, or libraries tailored to particular programming needs. The system may also recommend computing hardware solutions, such as optimized configurations for virtual machines, data storage options, or networking solutions designed to improve system performance and scalability.

To enhance accuracy and adaptability, the method or system incorporates an adaptive feedback loop where user interactions with the digital platform and computing interface, such as whether through approval, rejection, or modification of recommendations, are continuously fed back into a knowledge graph. This iterative process then retrains the machine learning model, thereby refining future recommendations and ensuring the system remains agile and responsive to changing users' preferences and other factors.

Additionally, as users interact with the system, their selections and feedback are continually integrated into the knowledge graph, which is updated with new market data, emerging trends, and newly available products. This continuous integration supports the retraining of the machine learning model and facilitates dynamic portfolio rebalancing, ensuring that future recommendations are increasingly accurate and responsive.

This method or system enables institutions to offer more inclusive, responsive, and sustainable digital products that dynamically adapt to evolving customer needs.

In one aspect, a computer-implemented method is provided that generates recommendations using a machine learning model. In this aspect, the system constructs a knowledge graph comprising nodes and edges that represent relationships between users, products, and historical interaction data. This graph is dynamically updated with real-time user feedback and external data. A supervised learning framework trains the machine learning model on labeled data from the knowledge graph, enabling the prediction of user preferences based on multi-dimensional constraints. The system then presents interactive elements via a GUI that are dynamically adjusted based on the model's analysis of user input. User responses are processed—using NLP techniques—to refine predictions, leading to the generation of digital product recommendations that comply with user-defined rules. Finally, feedback from user interactions is used to update the knowledge graph and retrain the model continuously.

In one aspect, the interactive elements presented via the GUI include dynamic questions, visual sliders, preference rankings, or textual prompts. This variety of input methods enables the system to capture detailed and intuitive user responses, thereby enhancing the accuracy of the preference data and the subsequent personalization of recommendations.

In one aspect, the multi-dimensional constraints in the method encompass ethical, religious, or environmental criteria. Integrating these broader constraints into the knowledge graph and the machine learning model ensures that the generated recommendations are aligned with the user's comprehensive values and lifestyle preferences.

In one aspect, the method applies NLP component to parse unstructured user input and generates follow-up interactive elements that help further refine the user's preference profile, thereby enhancing the overall personalization process.

In one aspect, the recommendations generated by the method include specialized digital products such as Sharia-compliant financial instruments, ESG-aligned investments, or sustainability-focused e-commerce products. This targeted approach allows users to receive suggestions that not only meet their functional needs but also adhere to specific ethical, religious, or environmental standards.

In one aspect, the computer-implemented method continuously monitors the compliance of recommended products by cross-referencing external regulatory databases in real time. When non-compliance is detected, the system automatically revises its recommendations to ensure that only products meeting all applicable standards are presented to the user.

In one aspect, when generating recommendations, the method further prioritizes products based on their similarity to selections made by users with overlapping constraints, thereby delivering recommendations that are highly relevant to each individual user.

In one aspect, the machine learning model in the method employs semantic analysis to generate contextually relevant follow-up interactive elements, further refining the user's preference profile and contribute to the accuracy of subsequent recommendations.

In one aspect, the knowledge graph in the method is continuously updated by integrating user input collected via the GUI, along with trends in customer preferences, market conditions, and newly available products. This ongoing integration enables the system to maintain a current and robust data foundation that supports accurate and timely recommendations.

In another aspect, an autonomous recommendation generation system is provided. The system comprises an input/output (I/O) device configured to display the GUI for both presenting interactive elements and receiving user responses, a processor configured to execute instructions for generating the knowledge graph, training and refining the machine learning model, generating recommendations, and updating both the knowledge graph and the model based on user feedback, and a communication interface that interconnects the processor and the I/O device. This integration facilitates efficient data exchange and establishes a closed-loop system for continuous improvement.

In another aspect, the interactive elements presented via the GUI include dynamic questions, visual sliders, preference rankings, or textual prompts. This variety of input methods enables the system to capture detailed and intuitive user responses, thereby enhancing the accuracy of the preference data and the subsequent personalization of recommendations.

In another aspect, the system applies the NLP component to parse unstructured user input and generates follow-up interactive elements that help further refine the user's preference profile, thereby enhancing the overall personalization process.

In another aspect, the processor continuously monitors the compliance of recommended products by cross-referencing external regulatory databases in real time. When non-compliance is detected, the system automatically revises its recommendations to ensure that only products meeting all applicable standards are presented to the user.

In another aspect, when generating recommendations, the processor prioritizes products based on their similarity to selections made by users with overlapping constraints. By analyzing historical data and shared preferences, the system delivers recommendations that are highly relevant to each individual user.

In another aspect, the machine learning model employs semantic analysis to interpret user input. This analysis generates contextually relevant follow-up interactive elements, which further refine the user's preference profile and contribute to the accuracy of subsequent recommendations.

In another aspect, the I/O device is configured to display rebalanced product portfolios in response to real-time market data. This ensures that users receive up-to-date recommendations that reflect current market trends and dynamically adjusted portfolio allocations.

In at least one aspect, the system analyzes user preferences on the digital platform system and generates a tailored collection of recommendations that meet a wide range of personalized requirements and adapt to evolving criteria.

In at least one aspect, there is provided a computer-implemented method for generating recommendations using a machine learning model, comprising: generating a knowledge graph comprising nodes and edges representing relationships between users relating to selection of prior products, and historical interactions with a user interface for selecting preferences relating to the products, wherein the knowledge graph is dynamically updated with real-time user feedback and external data; training a machine learning model using a supervised learning framework based on an input of labeled data from the knowledge graph indicative of the relationships, wherein the machine learning model is configured to predict products of interest based on multi-dimensional constraints; presenting, via a graphical user interface (GUI), a set of interactive elements to a user, wherein the interactive elements are dynamically adjusted based on output of the machine learning model, the interactive elements defining queries for determining current criteria for a user relating to products; receiving input responses via the GUI and applying the machine learning model to the responses using natural language processing (NLP) to predict recommendations for a set of products for display on the GUI; and updating the knowledge graph and retraining the machine learning model using feedback from interaction with the recommendations displayed on the GUI.

In at least one aspect, the machine learning model is further configured to generate a set of interactive questions to present on the UI as interactive elements to determine preferences and criteria for products based on prior questions and responses to the prior questions that the machine learning model has been trained for.

In at least one aspect, the machine learning model iteratively updates and triggers a conversational agent associated with the user interface to generate further responses on the user interface based on the input responses on the GUI defining preferences for digital products.

In at least one aspect, the machine learning model is further fed with a set of defined rules, commonalities and a list of available products to suggest for tuning an output prediction for the model for the products of interest.

In at least one aspect, the interactive elements include at least one of dynamic questions, visual sliders, preference rankings, or textual prompts.

In at least one aspect, the NLP parses the inputs on the user interface to infer contextual intent and generate follow-up interactive elements to receive subsequent inputs relating to preferences for the recommendations.

In at least one aspect, the recommendations comprise at least one of compliant digital instruments, or e-commerce products.

In at least one aspect, the method further comprising: monitoring compliance of recommendations of the set of products in real-time to the current criteria by cross-referencing external databases for product attribute updates; and automatically revising recommendations of products when non-compliance is detected.

In at least one aspect, the method further comprising prioritizing products for recommendations based on similarity to selections made by users with overlapping criteria.

In at least one aspect, the machine learning model employs semantic analysis to generate contextually relevant follow-up interactive elements for the GUI.

In at least one aspect, the method further comprising: updating the knowledge graph by continually integrating the user inputs via the GUI, trends in customer preferences, market conditions, and newly available products.

In yet another aspect, there is provided a computer-implemented system for autonomous recommendation generation, comprising a processor, a storage device and a communication device where each of the storage device, and the communication device is coupled to the processor, the storage device storing instructions, which when executed by the processor, configure the computing device to: generate a knowledge graph comprising nodes and edges representing relationships between users relating to selection of prior products, and historical interactions with a user interface for selecting preferences relating to the products, wherein the knowledge graph is dynamically updated with real-time user feedback and external data; train a machine learning model using a supervised learning framework based on an input of labeled data from the knowledge graph indicative of the relationships, wherein the machine learning model is configured to predict products of interest based on multi-dimensional constraints; present, via a graphical user interface (GUI), a set of interactive elements to a user, wherein the interactive elements are dynamically adjusted based on output of the machine learning model, the interactive elements defining queries for determining current criteria for a user relating to products; receive input responses via the GUI and applying the machine learning model to the responses using natural language processing (NLP) to predict recommendations for a set of products for display on the GUI; and update the knowledge graph and retrain the machine learning model using feedback from interaction with the recommendations displayed on the GUI.

In yet another aspect, there is provided a computer implemented method for automatically recommending digital products using a machine learning model, the method comprising: generating a knowledge graph of nodes and edges defining relationships between user profiles and user input selections selecting products on a user interface of a computer application thereby identifying users with similarities, the knowledge graph generated based on tracking historical data of prior selection for products based on user interface inputs and user preferences defined in the user interface, the knowledge graph tracking historical data via receiving user inputs from application programs relating to digital product selections; training a decision tree based machine learning model using a deductive supervised learning model based on receiving input of labelled data from the knowledge graph indicating relationship between users, products selected and user preferences selected in the user interface of the one or more application programs and a list of compliant products available, rules for products and a set of user interface training questions for training the machine learning model to determine preferences for product selection, inputs received for the training questions applied to a natural language processing model for determining the preferences; presenting on a display of the user interface a set of questions to determine current user characteristics and user preferences for products; and applying the machine learning model to the user preferences for products to determine a set of products to recommend for display on the user interface.

The above-referenced method may be included in the form of a non-transitory computer-readable medium having thereon computer-executable instructions for performing the above-referenced method.

### BRIEF DESCRIPTION OF THE DRAWINGS

These and other features of the invention will become more apparent from the following description in which reference is made to the appended drawings wherein:

FIG. 1 illustrates a machine learning based computer-implemented system and environment, comprising an AI decision tree based engine and knowledge graph for interaction with a requesting computing device to determine product recommendations, in accordance with one or more aspects of the present disclosure;

FIG. 2 illustrates a block diagram of example computing components of the computer-implemented system in further detail for receiving input user interface interactions (e.g. via a recommendation computer application of a requesting computing device) and providing output of recommended digital items in accordance with one or more aspects of the present disclosure;

FIG. 3 is flowchart of example operations for the computer-implemented system of FIGS. 1 and 2, in accordance with one or more aspects of the present disclosure; and

FIGS. 4A-4D illustrate example screen shots of the user interface of the recommendation application (e.g. on the requesting computing device of FIG. 1) for interactively presenting a customized user interface, in accordance with one or more aspects of the present disclosure.

### DETAILED DESCRIPTION

In at least some aspects, there is provided a computerized system and method for generating personalized product recommendations through an interactive user interface via a machine learning based computing system. The system utilizes a machine learning model based on a decision tree and a knowledge graph, using a deductive learning approach within a supervised framework. The machine learning based computing system interacts with users via a user interface screen, generating a set of tailored questions designed to capture user preferences, such as their desired account types, adherence to specific rules (e.g., compliance), and interests. In some aspects, based on user responses received on the requesting computing device, the machine learning based computing system recommends and presents for interaction a tailored mix of digital products, which can then be adjusted through the user interface. The feedback provided on the interface is continually fed back into the machine learning model of the system to refine future recommendations.

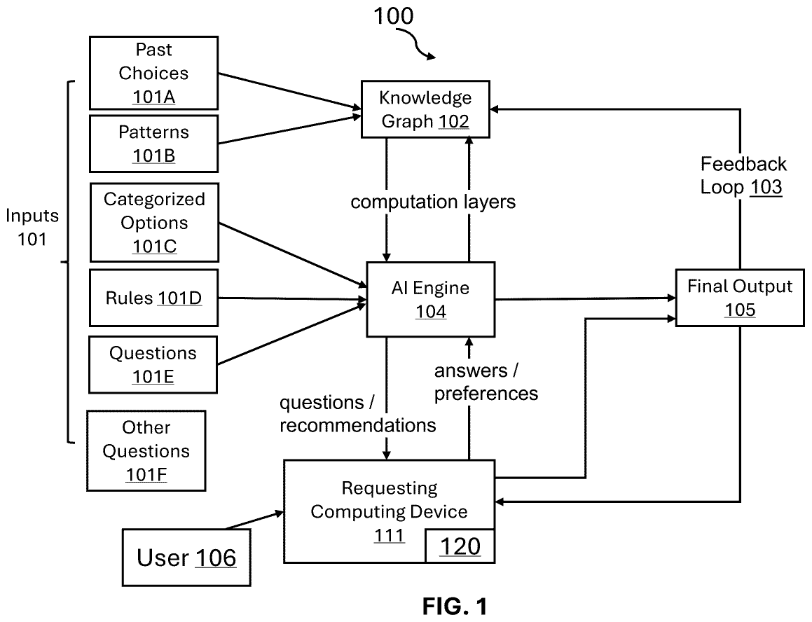

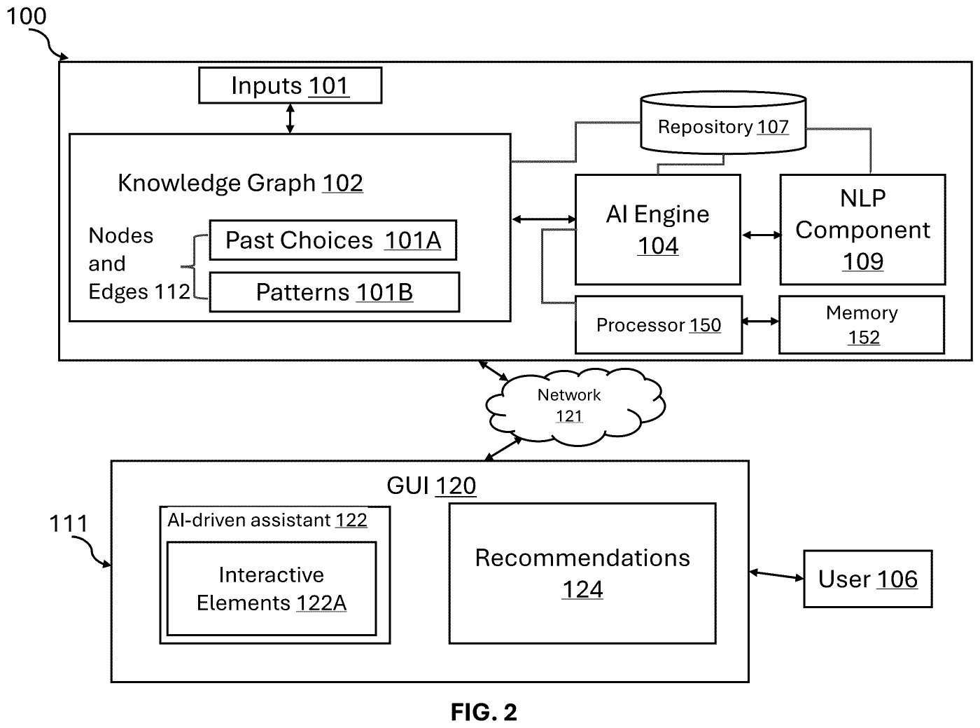

As shown in FIG. 1, a machine learning based computer system 100 serves as a central component for managing user interactions with a graphical user interface and generating personalized recommendations for a recommendations application for display on the user interface. As shown in FIG. 1, in some aspects, the requesting computing device 111 with the graphical user interface (e.g. GUI 120 shown in FIG. 2) is a separate computing device having a processor, communication device, a memory storing instructions for execution by the processor to execute the operations disclosed herein and for providing a GUI 120. In another aspect, the operations of the requesting computing device 111 and the GUI 120 may form part of the computing system 100.

In some aspects, the requesting computing device 111 and the computing system 100 communicate across a computing network 121. The computer network 121 may include wired or wireless communication channels, such as the Internet, local area networks (LANs), wide area networks (WANs), cellular networks (e.g., 4G/5G), or cloud-based distributed networks.

Referring again to FIG. 1, the computing system 100 processes various structured inputs 101, including but not limited to: past choices 101A, patterns 101B, categorized options 101C (e.g., products or services that meet specific criteria), predefined rules 101D for different user profiles, a set of configurable questions 101E designed to capture individual preferences and objectives, and other inputs 101F).

For example, the categorized options 101C can include but not limited to: compliant digital offerings, ESG compliant digital offerings, or other sustainability-focused digital or e-commerce products. These options may further encompass digital resources, digital services, computing applications, compliance software, and other digital products.

The set of predefined rules 101D for different user profiles may include but not limited to: digital accounts, resource accounts or e-commerce accounts. In the case of financial accounts, this may encompass but not limited to investment accounts, credit card accounts, savings or chequing account or different types of digital financial instruments. Other types of accounts, such as digital accounts for accessing computing resources including various types of accounts for different types of digital resources, may be envisaged. Other types of e-commerce digital accounts may also be envisaged in certain examples.

These inputs help define the decision-making framework, allowing the system to adapt digital recommendations provided to the requesting computing device 111 and the GUI 120 based on user-defined constraints and dynamic changes in available options.

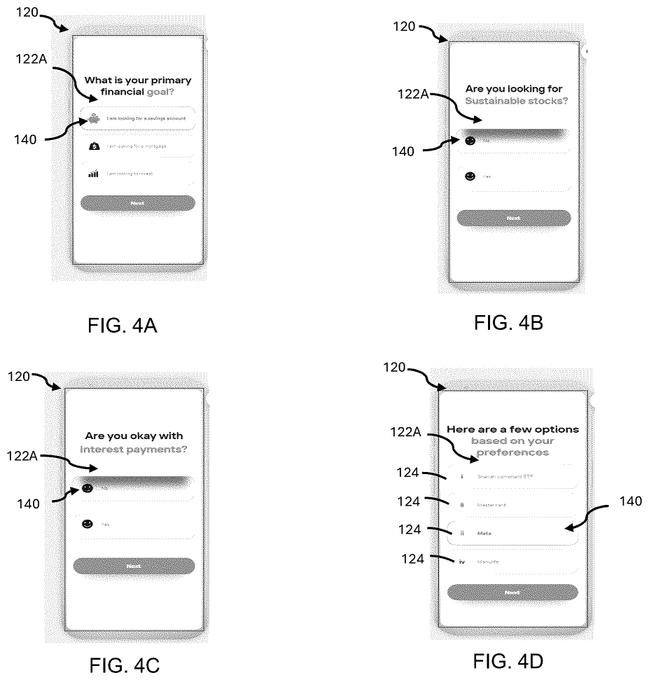

The AI engine 104 includes at least one decision tree based component utilizing a decision tree model to process these inputs 101 and define a structured interaction process for the GUI 120 on the requesting computing device 111 for the user 106 to interact with via one or more screens (e.g. as shown in FIGS. 2 and 4). The AI decision tree based component shown as the AI engine 104 may be configured for generating relevant questions (e.g. in cooperation with the NLP component 109), capturing customer preferences on the customer application (e.g. AI driven assistant 122), and applying prediction technique derived from the decision trees to suggest tailored products and account configurations for the GUI 120.

The user 106 may interact with AI decision tree based component provided by the AI engine 104 (e.g. via the requesting computing device 111 and/or the GUI 120) answering questions and providing information about account preferences, such as specific requirements (e.g. digital asset goals) or values they prioritize (e.g., sustainability, or compliance with certain guidelines). The decision tree model of the AI engine 104 ensures that the interaction presented via one or more screen on the user interface, such as via a set of questions and forms is structured, allowing for real-time adjustments based on the user's responses provided on the GUI 120.

Once user preferences and inputs are gathered on the GUI 120, the AI decision tree based component provided by the AI engine 104 interacts with a knowledge graph 102. The knowledge graph 102 may serve as a repository of information (the contents of which may also be fully or partially stored in repository 107), containing nodes and edges representing relationships between users, products, and historical interaction data, such as the user's past choices 101A, and patterns observed among users with similar profiles or goals—as provided by patterns 101B). The nodes and edges within the knowledge graph 102 are dynamically updated with real-time user feedback and external data to reflect evolving preferences, changing conditions, and newly available information.

Based on the inputs to the GUI 120 and/or the interactions with the AI driven assistant 122, the AI decision tree based component provided by the AI engine 104 retrieves recommendations from the knowledge graph 102. These recommendations are defined to align with the user's preferences, selected parameters, and any applicable constraints (e.g., for digital financial products this may include but not limited to: restrictions on debt levels, and asset classes for compliant products). The AI decision tree based component of the AI engine 104 then presents these recommendations back to the user 106 through an interactive interface via the GUI 120, allowing for review and further customization.

The GUI 120 is configured via the output information from the computing system 100 to trigger the generation of specific content and user interface screens which allows refining or adjusting the suggested options to create a personalized selection that aligns with individual preferences. Users can interact with the GUI 120 to modify the proportions of different recommended options, prioritize certain categories, or apply additional filters based on their evolving criteria, such as including a higher proportion of a certain type of compliant product or weighting their digital asset portfolio of holdings toward environmentally sustainable options. Other uses may be envisaged such as allocation of digital resources, etc. Once the user 106 interacts with the GUI 120 (e.g. via the AI driven assistant 122) and finalizes the selection, the system generates a final output 105 for review and approval (e.g. a set of recommended products based on the user interactions with the GUI 120 as processed via the computing system 100 including the knowledge graph 102 and the AI engine 104 processing various inputs and training data) which may then be displayed on the GUI 120 as shown in FIG. 1.

After receiving an input selection on the GUI 120 indicative of a confirmation, the finalized selection is incorporated into the knowledge graph 102 as feedback. In at least some aspects, this feedback loop 103 conveniently allows for refining future recommendations, as it allows the AI decision tree based component of the AI engine 104 to learn from user interactions and inputs with the GUI 120 (e.g. via the screens shown in FIG. 4 and/or the AI driven assistant 122) and improve its ability to generate more relevant suggestions over time.

The AI decision tree based component of the AI engine 104 continuously monitors the relevance and compliance of the recommended options of digital products with applicable guidelines or user-defined parameters as may be generated by the AI engine 104 and/or the knowledge graph 102. If an option no longer meets the required criteria (e.g., due to changing conditions or updated policies), the system 100 automatically notifies the requesting computing device 111 and thereby the user 106 and suggests alternative options that align with the updated information. This proactive approach ensures that the computing system 100 provides end users consistently with up-to-date and relevant recommendations. For example, if a previously recommended product or service ceases to meet a specific criterion (such as sustainability or ethical standards), the system 100 will flag the change and offer a replacement option of a digital offering or product that remains compliant.

Generally, the machine-learning based computer system 100 of FIG. 1 integrates various inputs 101, dynamically interacts with a knowledge-driven recommendation system provided via the knowledge graph 102 and the AI engine 104 and provides a continuous feedback loop 103 to enhance engagement, customization of the UI and decision-making accuracy. The system is designed to provide a seamless, adaptive experience, ensuring that users receive tailored recommendations that evolve in response to changing needs, preferences, and external conditions.

As shown in FIG. 2, further components and communication of the computing system 100 providing a computing device employing an AI decision tree based component shown as an AI engine 104 and a knowledge graph 102 (e.g., the knowledge graph depicting relationships and connectivity uncovering hidden patterns created using historical user preferences, trends, and selections of prior products) to generate product recommendations 124 (e.g. digital recommendations) for a requesting computing device 111 to be displayed on the GUI 120. The knowledge graph 102 contains nodes and edges 112 representing relationships between users, products, and historical interaction data, such as the user's past choices 101A, and patterns observed among users with similar profiles or goals (e.g. patterns 101B). Other inputs 101 may also be processed by the knowledge graph 102 for providing to the AI engine 104. In some aspects, the knowledge graph 102 is a structured data model that represents relationships between users, digital products, categorical inputs, decision rules, and historical interactions within the machine learning computing system 100.

FIG. 2 illustrates an example computing architecture in which a processor 150 and memory 152 facilitate operations of the system 100. The processor 150 may be implemented as a single-core processor, a multi-core processor, multiple processors with single or multiple cores, or any combination thereof, enabling efficient parallel processing and execution of machine-learning models such as within the AI engine 104 and decision-making logic such as in the knowledge graph 102, and data processing tasks described herein.

The memory 152 may include one or more of main memory, static memory, and storage, each communicatively coupled to the processor 150 via a system bus (not shown). The memory 152 stores instructions that, when executed by the processor 150, enable various system functionalities, including processing user interactions via the requesting computing device 111 such as the GUI 120 including the AI driven assistant 122, executing AI-driven recommendation processes using the AI engine 104, and dynamically updating the knowledge graph 102 based on user feedback provided on the GUI 120

During execution, these instructions may reside entirely or partially within different sections of memory 152, including volatile memory (e.g., RAM), non-volatile memory (e.g., flash storage), or machine-readable media. Additionally, portions of the instructions may be cached within processor 150 to optimize real-time decision-making and reduce latency in generating and updating recommendations.

In one example operation, a user 106 interacts with the system via an AI-driven assistant 122 (e.g. AI bot or chatbot) presented on the GUI 120. The GUI 120 may be associated with a requesting computing device 111, having a processor, memory and instructions stored thereon for performing the operations described herein. The AI-driven assistant 122 may generate a series of personalized interactive elements 122A for display on the GUI 120 designed to understand the preferences and goals of the end user 106. While an AI driven assistant 122 is defined in some aspects as a chatbot, in other aspects, may be a computer application providing an interactive interface for the GUI 120 as described herein, such as to generate the figures shown in FIG. 4.

The AI-driven assistant 122 dynamically adjusts the interactive elements 122A based on the analysis of the user's input (which may be provided by AI engine 104 in communication with the requesting computing device 111), ensuring a more refined understanding of user needs. Recommendations 124 are subsequently displayed on the GUI 120, personalized to the specific preferences and profile of the user 106. These recommendations are specifically curated to align with the user's profile, preferences, and previously defined objectives, offering a highly personalized decision-making experience.

In some aspects, the AI driven assistant 122 facilitates communication by receiving inputs on the GUI 120, processing those inputs, and providing personalized responses or suggestions on the display, such as via communication with the AI engine 104. The interface 120 may include text-based or voice-based interaction options, enabling the user 106 to engage in a dynamic, conversational exchange with the assistant. The AI assistant 122 is designed to understand user queries, preferences, and behaviors, leveraging advanced natural language processing (NLP) (e.g. via the NLP component 109), machine learning models (e.g. via the AI engine 104) and knowledge graph 102 to interpret the context of interactions and deliver relevant content or recommendations. Through this interaction, the AI assistant 122 can assist in navigating the computer applications, making decisions, and suggesting digital offerings that align with the end user of the GUI 120 specific needs and goals.

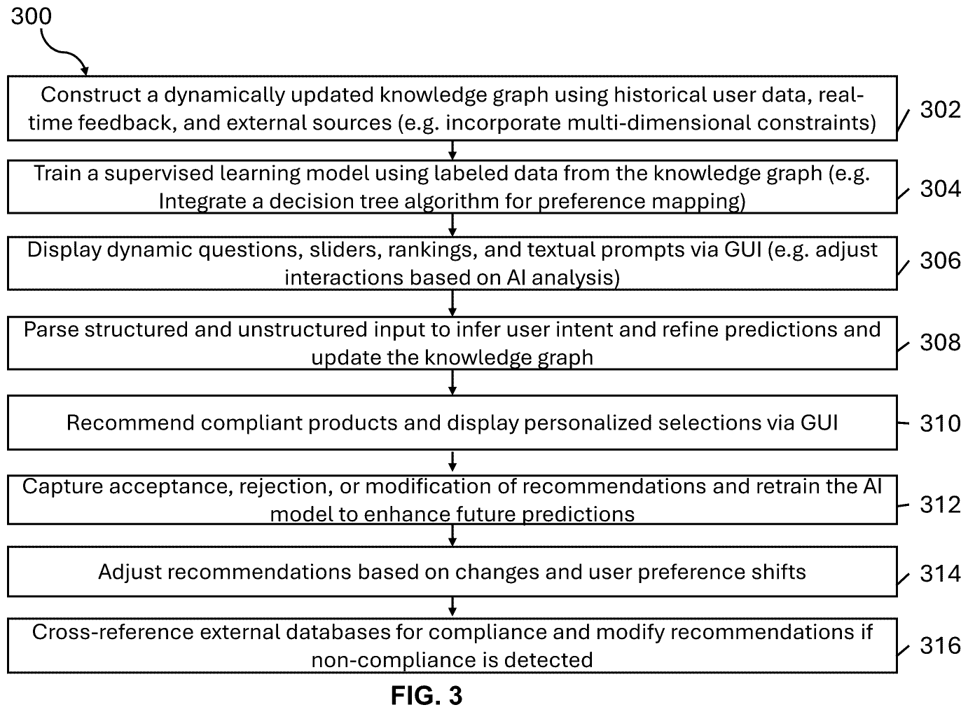

Referring to FIG. 3, shown is a flowchart illustrating example operations 300 of the computer-implemented system for autonomous recommendation generation of FIG. 1 and FIG. 2, in accordance with an aspect of the present disclosure.

At 302, a knowledge graph 102 is generated comprising nodes and edges representing relationships between users, products, and historical interaction data (e.g. interactions on the GUI 120 and/or the AI driven assistant 122). In particular, the knowledge graph 102 is dynamically updated based on real-time user feedback provided on the GUI 120 (e.g. input in response to the interactive elements 122A) and external data sources. The knowledge graph 102 is configured to ingest and capture user preferences provided on the requesting computing device by tracking selections made via the GUI 120 such as in response to the AI driven assistant 122 (e.g. chatbot) and by integrating behavioral trends from similar users. In one aspect, the knowledge graph 102 also incorporates multi-dimensional constraints, including various predefined and/or user defined criteria, to tailor recommendations to the user's specific preferences.

In one or more example aspects, as constraints (e.g. provided on the GUI 120 with respect to the generation of digital products of interest) evolve, the graph 102 is continuously updated, enabling real-time querying for adaptive recommendations. Graph-based algorithms, including shortest path traversal, clustering, and constraint satisfaction techniques, facilitate efficient filtering and selection based on multi-dimensional and dynamically changing parameters. This approach ensures that the recommendation system provided by the computing system 100 via the AI engine 104 can autonomously process complex, evolving constraints while maintaining computational efficiency and scalability.

At 304, the AI engine 104 applies a machine learning model trained using a supervised learning framework. In one or more aspects, the AI engine applies deductive supervised learning that combines elements of supervised learning with deductive reasoning to improve model predictions based on structured logical rules and labeled data.

For example, the model may be trained on labeled datasets, where input data points are paired with known correct outputs so that the system learns patterns from historical data to make predictions on new, unseen data and the model then applies logical inference rules or predefined constraints to refine predictions so that it ensures that outputs adhere to structured knowledge.

The AI engine 104 processes labeled data from the knowledge graph 102, as well as categorized options 101C (e.g., products or services that meet specific criteria), predefined rules 101D for different user profiles, a set of configurable questions 101E designed to capture individual preferences and objectives, and other inputs 101F. These inputs 101 are used to train the machine learning model of the AI engine to determine preferences for product selection. The trained model predicts user preferences by analyzing patterns across historical data and real-time inputs. The machine learning model of the AI engine 104 then integrates a decision tree algorithm within the knowledge graph 102, allowing it to map user preferences to categorized options with high accuracy.

At 306, the system presents interactive elements 122A via the GUI 120 (e.g. as may be presented to a requesting computing device 111) to engage user input for the user 106. These interactive graphical user interface elements may include dynamic questions, visual sliders, preference rankings, and textual prompts, (e.g. see FIG. 4) enabling the user to provide structured and unstructured input regarding preferences. The AI-driven assistant 122 may be triggered via the outputs from the computing system 100 to dynamically adjust these interactive elements based on the machine learning model's (e.g. AI engine 104) analysis of the user inputs on the interface (e.g. including prior inputs from the user and similar users on the user interface of the GUI).

At 308, the system receives user input and responses through the GUI 120 and applies NLP (natural language processing) using the NLP component 109 techniques to interpret and refine the machine learning model's (AI engine 104) predictions. The NLP module parses unstructured user input to infer contextual intent and generate follow-up interactive elements, further refining the system's understanding of the user's preferences. The knowledge graph 102 is updated with both explicit selections and inferred preferences, enhancing the accuracy of future recommendations. For example, at 308, the system receives user input via a graphical user interface, GUI 120 specifying preference parameters associated with digital asset selection. The preference parameters may include risk tolerance levels, sustainability criteria, compliance constraints, or other selection rules.

At 310, the system generates digital recommendations 124 for digital products that comply with previously defined rules and predicted preferences. The recommendations 124 may include but not limited to: software applications, cloud computing resources, digital media content, and configuration settings for computing environments, aligning with preferences specified by the user on the user interface. The recommendations 124, presented on the GUI 120, are tailored to the user's profile, preferences, and constraints derived from the knowledge graph 102. In some specific examples, the recommendations 124 may include compliant financial instruments, ESG-aligned investments, and sustainability-focused e-commerce products, aligning with particularly defined considerations specified by the user. The recommendations 124, presented on the GUI 120, tailored to the user's profile, preferences, and constraints derived from the knowledge graph 102.

For example, in some aspects, at 310, based on the received input on the GUI 120, the system generates personalized recommendations 124 for the GUI by processing the parameters through a particular structured data model, such as the knowledge graph 102. In some example aspects, the recommendations 124, displayed on the GUI 120, may be dynamically ranked and adjusted in response to real-time updates to user preferences as input to the GUI 120.

In some aspects, at 310, the system receives user input via an AI driven graphical user interface GUI 120, where the AI-driven assistant 122 dynamically presents interactive elements 122A designed to capture user preferences. These interactive elements 122A may include GUI elements including structured questions, dropdown menus, toggle switches, and sliders, allowing users of the GUI to define selection criteria such as compliance constraints, sustainability preferences, and risk tolerance levels (e.g. see FIGS. 4A-4D). The AI engine 104 may then analyze the input responses in real time, applying predefined rules and deductive learning within a supervised framework. The system 100 then is configured to refine the set of questions presented on the user interface of the GUI 120 based on prior inputs, ensuring a structured decision-making process.

In some example aspects, as user preferences are captured, the AI decision tree-based component shown as AI engine 104 interacts with a knowledge graph 102, which contains nodes and edges representing relationships between digital products, historical user selections (e.g. choices 101A), and patterns identified among users with similar profiles or goals (e.g. patterns 101B). The knowledge graph dynamically updates based on user input and external data sources, ensuring the recommendations 124 remain current. The AI-driven assistant 122 continuously updates the GUI 120 with revised recommendations 124, adjusting rankings and categorizations in response to real-time user modifications.

In some aspects, the GUI 120 supports iterative refinement. As users interact with the requesting computing device 111 via the GUI 120, the feedback is incorporated into the knowledge graph 102 through a continuous feedback loop 103. This iterative learning process improves future recommendations 124 by the system by adapting to GUI behaviors and input preferences. If a recommended digital asset no longer meets predefined constraints—due to updated policies, changing compliance standards, or evolving digital asset conditions—the system 100 automatically flags the change and suggests an alternative that remains compliant.

At 312, user feedback on the recommendations 124 on the GUI 120—whether acceptance, rejection, or modification—is incorporated back into the knowledge graph 102. The machine learning model within AI engine 104 is retrained using this feedback, ensuring continuous refinement of future predictions and an adaptive recommendation process.

In at least some aspects, this feedback is structured, labeled, and stored within a feedback repository (e.g. repository 107), where it is categorized by the computing system 100 based on interaction type, response pattern, and modification context. In some examples, the knowledge graph 102 dynamically incorporates this feedback by adjusting edge weights, adding new nodes, or modifying relationships between existing entities.

In some examples, the AI engine 104 initiates retraining by extracting feedback-driven updates from the knowledge graph 102 and feeding them into the machine learning framework of the AI engine 104. It first vectorizes structured and unstructured feedback data using graph-based embeddings which encode relationship dynamics within the knowledge graph into a format suitable for machine learning processing.

At 314, in some optional aspects, the system 100 rebalances product portfolios displayed via the GUI 120 as recommendations 124 in response to changes in market conditions or user preferences. The updated recommendations ensure that product offerings remain aligned with user needs and evolving external factors.

At 316, the system monitors the compliance of recommended products in real-time by cross-referencing external sources, e.g. external compliance databases to ensure that criteria is met even based on changing product features and attributes in the online platform. If a recommended product is found to be non-compliant due to changes in the data attributes or updates, the system automatically revises the recommendations to ensure continued compliance with applicable standards.

FIGS. 4A-4D illustrate an example of a user interface and corresponding screens generated by the AI engine 104 for display on the GUI 120 (e.g. of FIGS. 1 and 2). FIGS. 4A-4C depict the dynamic and interactive GUI 120 with various interactive elements 122A, including buttons, sliders, input fields, and question prompts (e.g. product goal, the type of product they are looking for, and whether they are agreeable with terms of products, etc.). Inputs may be made by selecting choice options and answering the questions presented on the user interface. The elements may generated by an AI-driven assistant 122 (e.g. in cooperation with outputs received dynamically from the computing system 100), as detailed in FIGS. 1 and 2, which leverages both historical data and real-time user inputs 140 to continuously refine its predictions.

FIG. 4D shows the GUI 120 providing recommendations 124 by presenting refined options based on the user's preferences, from which users can select. As input interactions are received on the interface, such as accepting, denying, or modifying the recommended digital products, the responses on the GUI 120 may be captured and processed using NLP techniques on the NLP component 109. In some aspects, this processing not only interprets explicit feedback but also extracts nuanced information from user interactions, enabling the system to adjust the recommendations 124 in real time. The computing system 100 cross-references these inputs with the relationships defined in the knowledge graph 102, ensuring that evolving preferences and external factors are accurately reflected.

Specifically, following the interaction, the response of users are fed back into the knowledge graph 102 within the computing system 100. This information is then used to retrain the machine learning model of the AI engine 104 incorporating newly labeled data from the knowledge graph 102. This continuous feedback loop ensures that future recommendations remain highly personalized, accurate, and compliant with user-defined rules. In this manner, as users interact with the system, the interface continually updates and refines recommendations based on real-time inputs, market fluctuations, and changes in user preferences. The dynamic adjustments ensure that recommendations 124, remain aligned with the user's evolving goals and constraints, by rebalancing them as necessary to maintain compliance with the dynamically changing rules and external factors.

One embodiment of the system includes a user interface (e.g. GUI 120) configured to collect transaction information from the user, such as textual descriptions, preferences, past behaviors, or other relevant data for the recommendation system. This input helps the system understand the user's interests and requirements. The input may undergo NLP techniques to parse and analyze its structure, semantics, and meaning, enabling the system to effectively comprehend the user's input. Additionally, using the NLP techniques, the system may generate relevant follow-up questions based on the user's input and/or information extracted from a knowledge graph.

One embodiment of the system includes an interactive chatbot interface or conversational agent (e.g. AI driven assistant 122) that enables real-time, conversational interactions with users. The chatbot utilizes NLP to guide users through the recommendation process, answer questions about financial products, and clarify investment strategies. By integrating with the knowledge graph and recommendation engine, the chatbot provides instant, context-aware responses to user queries, enhancing the overall user experience.

One embodiment of the system includes the use of semantic analysis to ensure that the generated questions (e.g. as interactive elements 122A) accurately capture the essence of the user's input and feedback. This process involves analyzing the context and intent behind user statements to create meaningful and relevant questions. The system may also present these questions on a user interface, allowing users to respond directly through the interface. Based on the input received, a recommendation generation engine, utilizing one or more machine learning models, produces personalized product recommendations, and may initiate automated actions to complete related transactions. Additionally, the system may include a feedback mechanism that gathers user input on the relevance of the questions and recommendations, feeding this data back into the machine learning model to continuously improve its performance. Further, the system's user interface (e.g. GUI 120) may be designed to display product recommendations that comply with the regulations, laws, and requirements specified by the user.

One embodiment of the system includes a filtering mechanism that leverages anonymized user interaction data to enhance recommendation accuracy. By analyzing patterns in similar users' preferences and selections, the system can identify relevant products that may not have been explicitly specified by an individual user but align with their inferred interests and values. This enables more precise and proactive recommendations tailored to user needs.

In summary, this invention provides a sophisticated machine learning based computing system that adapts to user preferences and real-time market data. By leveraging machine learning, decision tree algorithms, and a constantly updated knowledge graph, the system generates highly personalized product recommendations that meet a wide range of requirements.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure. In addition, the figures are not to scale and may have size and shape exaggerated for illustrative purposes.

One or more currently preferred embodiments have been described by way of example. Variations and modifications to the described embodiments may be made without departing from the scope of the invention as defined in the claims.

What is claimed is:

1. A computer-implemented method for generating recommendations using a machine learning model, comprising:
generating a knowledge graph comprising nodes and edges representing relationships between users relating to selection of prior products, and historical interactions with a user interface for selecting preferences relating to products, wherein the knowledge graph is dynamically updated with real-time user feedback and external data;
training a machine learning model using a supervised learning framework based on an input of labeled data from the knowledge graph indicative of the relationships, wherein the machine learning model is configured to predict products of interest based on multi-dimensional constraints;
presenting, via a graphical user interface (GUI), a set of interactive elements to a user, wherein the interactive elements are dynamically adjusted based on output of the machine learning model, the interactive elements defining queries for determining current criteria for a user relating to products;
receiving input responses via the GUI and applying the machine learning model to the responses using natural language processing (NLP) to predict recommendations for a set of products for display on the GUI; and
updating the knowledge graph and retraining the machine learning model using feedback from interaction with the recommendations displayed on the GUI.

2. The method of claim 1 wherein the machine learning model is further configured to generate a set of interactive questions to present on the UI as interactive elements to determine preferences and criteria for products based on prior questions and responses to the prior questions that the machine learning model has been trained for.

3. The method of claim 1 wherein the machine learning model iteratively updates and triggers a conversational agent associated with the user interface to generate further responses on the user interface based on the input responses on the GUI defining preferences for digital products.

4. The method of claim 1, wherein the machine learning model is further fed with a set of defined rules, commonalities and a list of available products to suggest for tuning an output prediction for the model for the products of interest.

5. The method of claim 1, wherein the interactive elements include at least one of dynamic questions, visual sliders, preference rankings, or textual prompts.

6. The method of claim 5, wherein the NLP parses the inputs on the user interface to infer contextual intent and generate follow-up interactive elements to receive subsequent inputs relating to preferences for the recommendations.

7. The method of claim 6, wherein the recommendations comprise at least one of compliant digital instruments, or e-commerce products.

8. The method of claim 7, further comprising:
monitoring compliance of recommendations of the set of products in real-time to the current criteria by cross-referencing external databases for product attribute updates; and
automatically revising recommendations of products when non-compliance is detected.

9. The method claim 8, further comprising prioritizing products for recommendations based on similarity to selections made by users with overlapping criteria.

10. The method of claim 9, wherein the machine learning model employs semantic analysis to generate contextually relevant follow-up interactive elements for the GUI.

11. The method of claim 10, further comprising:
updating the knowledge graph by continually integrating the user inputs via the GUI, trends in customer preferences, market conditions, and newly available products.

12. A computer-implemented system for autonomous recommendation generation, comprising a processor, a storage device and a communication device where each of the storage device, and the communication device is coupled to the processor, the storage device storing instructions, which when executed by the processor, configure the computer system to:
generate a knowledge graph comprising nodes and edges representing relationships between users relating to selection of prior products, and historical interactions with a user interface for selecting preferences relating to the products, wherein the knowledge graph is dynamically updated with real-time user feedback and external data;
train a machine learning model using a supervised learning framework based on an input of labeled data from the knowledge graph indicative of the relationships, wherein the machine learning model is configured to predict products of interest based on multi-dimensional constraints;
present, via a graphical user interface (GUI), a set of interactive elements to a user, wherein the interactive elements are dynamically adjusted based on output of the machine learning model, the interactive elements defining queries for determining current criteria for a user relating to products;
receive input responses via the GUI and applying the machine learning model to the input responses using natural language processing (NLP) to predict recommendations for a set of products for display on the GUI; and
update the knowledge graph and retrain the machine learning model using feedback from interaction with the recommendations displayed on the GUI.

13. The system of claim 12 wherein the machine learning model is further configured to generate a set of interactive questions to present on the UI as interactive elements to determine preferences and criteria for products based on prior questions and responses to the prior questions that the machine learning model has been trained for.

14. The system of claim 12 wherein the machine learning model iteratively updates and triggers a conversational agent associated with the user interface to generate further responses on the user interface based on the input responses on the GUI defining preferences for digital products.

15. The system of claim 12, wherein the machine learning model is further fed with a set of defined rules, commonalities and a list of available products to suggest for tuning an output prediction for the model for the products of interest.

16. The system of claim 12, wherein the interactive elements include at least one of dynamic questions, visual sliders, preference rankings, or textual prompts.

17. The system of claim 16, wherein the NLP parses the inputs on the user interface to infer contextual intent and generate follow-up interactive elements to receive subsequent inputs relating to preferences for the recommendations.

18. The system of claim 17, further comprising:
monitoring compliance of recommendations of the set of products in real-time to the current criteria by cross-referencing external databases for product attribute updates; and
automatically revising recommendations of products when non-compliance is detected.

19. The system of claim 18, further comprising prioritizing products for recommendations based on similarity to selections made by users with overlapping criteria.

20. A computer implemented method for automatically recommending digital products using a machine learning model, the method comprising:
generating a knowledge graph of nodes and edges defining relationships between user profiles and user input selections selecting products on a user interface of a computer application thereby identifying users with similarities, the knowledge graph generated based on tracking historical data of prior selection for products based on user interface inputs and user preferences defined in the user interface, the knowledge graph tracking historical data via receiving user inputs from application programs relating to digital product selections;
training a decision tree based machine learning model using a deductive supervised learning model based on receiving input of labelled data from the knowledge graph indicating relationship between users, products selected and user preferences selected in the user interface of the one or more application programs and a list of compliant products available, rules for products and a set of user interface training questions for training the machine learning model to determine preferences for product selection, inputs received for the training questions applied to a natural language processing model for determining the preferences;
presenting on a display of the user interface a set of questions to determine current user characteristics and user preferences for products; and
applying the machine learning model to the user preferences for products to determine a set of products to recommend for display on the user interface.
